(19) United States
(12) Patent Application Publication
(10) Pub. No.: US 2005/0136876 A1
(43) Pub. Date: Jun. 23, 2005

(54) Tower mounted amplifier filter and manufacturing method thereof

(75) Inventor: Niels Broholm, Copenhagen (DK)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 10/976,841

(22) Filed: Nov. 1, 2004

(30) Foreign Application Priority Data
Dec. 19, 2003 (EP) 03029337.7

(51) Int. Cl. H04B 1/10

(52) U.S. Cl. 455/307

(57) ABSTRACT

A tower mounted amplifier filter for use in mobile base station antenna masts comprising three TMA filter functions, two reception path filters separated by a low noise amplifier and one transmission path filter, implemented by means of coaxial resonator cavities, two of them being common resonators where the receive and transmission paths are combined in two output/input ports for connection with external devices, the body housing of the filter being made of thermoplastic material with high content of glass- and mineral-fillers, and coated with an electrical conductive material.

### BACKGROUND OF THE INVENTION

The invention is based on a priority application EP 03029337.7 which is hereby incorporated by reference.

The present invention relates generally to the use of Tower Mounted Amplifiers (TMA) in base stations for mobile telephony, and more particularly to a TMA coaxial cavity filter.

Many types of filters are used today in base stations for mobile telephony. Often these filters are formed from central conductors placed inside a cavity or a number of cavities known as coaxial cavity resonators. The walls of this cavity or cavities are conductive and usually formed by the inner surface of a filter-casing.

Filters formed by coaxial cavity resonators are widely known and used in telecommunication applications, for example, such type of filters can be found in patent applications like U.S. Pat. No. 3,955,161, U.S. Pat. No. 5,329,687 and U.S. Pat. No. 6,392,506.

On the other hand, TMAs have been recently gaining relevance in the cellular network industry. Basically, a TMA is a device which comprises waveguide reception and transmission filters and low noise amplifiers. Such devices, usually installed directly behind the base station antennas, amplify the received signals at the top of the base station antenna mast in order to improve the overall system sensibility of a mobile network base station. By amplifying the signals as near as possible to the antennas, they compensate the cable and connector losses between the antenna and the input of the base station.

Nowadays, TMA filter equipment is manufactured in aluminum (machined or casted), so the installation or replacement of said TMA equipment at the top of the base station antenna mast implies a tedious and hard process in which the installers or maintenance personnel shall carry said heavy equipment up and down from the mast. Further, the cost of manufacturing said equipment in aluminum is expensive and the life of the equipment is relatively short.

### SUMMARY OF THE INVENTION

Accordingly, it is the object of the invention to solve the aforesaid technical problems of prior art TMA filters and provide a novel and improved solution.

The object is achieved according to the invention by
a tower mounted amplifier filter for use in mobile base station antenna masts comprising three TMA filter functions, two reception path filters, separated by a low noise amplifier and one transmission path filter implemented by means of coaxial resonator cavities, two of them being common resonators where the receive and transmission paths are combined in two output/input ports for connection with external devices, the body housing of the filter being made of thermoplastic material with high content of glass- and mineral-fillers, and coated with an electrical conductive material; and
a method for manufacturing a tower mounted amplifier filter according to the present invention comprising the steps of moulding the filter body housing in thermoplastic, coating said housing with an electrical conductive material, and fitting a trimming plate to cover the body housing.

When equipment needs to be mounted in the mast close to the antenna, weight is a very important parameter to compete with. For example, a normal tri-sector with cross polarized antennas needs also three dual duplexed triplexers mounted close to the antennas, and the installers are therefore interested in carrying as few kilos as possible up in the most. By using a TMA equipment comprising a TMA filter according to the present invention, the weight which shall be carried is reduced considerably.

Other advantageous configurations of the invention emerge from the dependent claims, the following description and the drawings. For example, it is seen advantageous that by manufacturing the TMA filter according to the invention the need for secondary machining is minimized and the cost of the final product is reduced. Furthermore the filter lifetime is considerably higher compared with conventional machined or casted aluminum filters. The lifetime of the mould when injection moulding thermoplastic material is used is at least ten times higher compared to die's used for pressure die-casting.

### BRIEF DESCRIPTION OF THE DRAWINGS

An embodiment example of the invention is now explained with the aid of FIGS. 1 to 3.

FIG. 1A,B shows a block diagram of a TMA comprising reception and transmission link filters according to the invention.

FIG. 2A,B shows a perspective sectional front and back view of the preferred embodiment of the TMA filter implementation according to the present invention.

FIG. 3A,B shows a perspective partial view of TMA filter according to the invention with connectors mounted onto the housing.

### DETAILED DESCRIPTION OF THE DRAWING

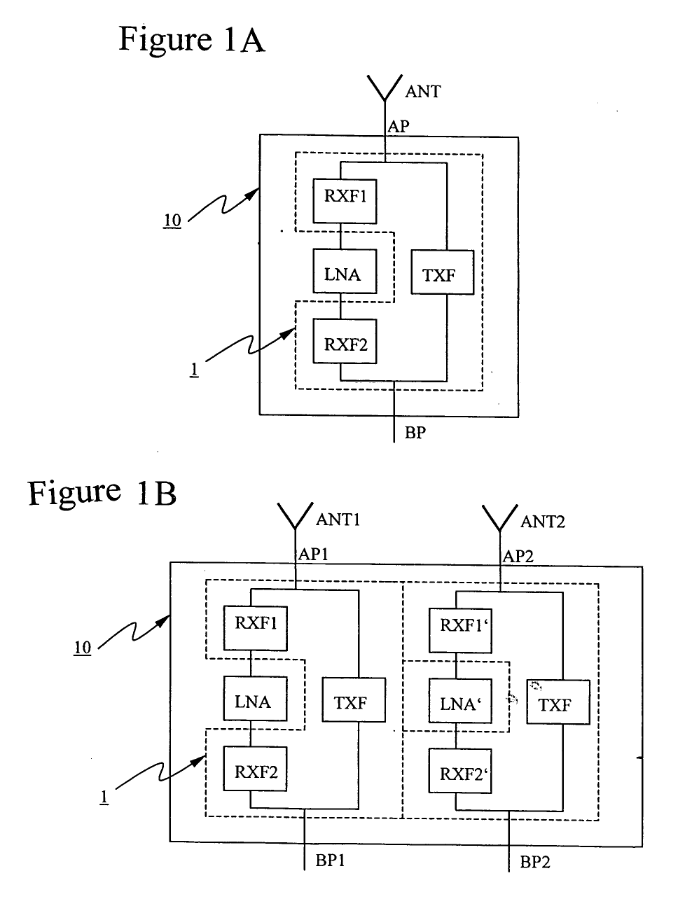

FIG. 1A shows a block diagram of a TMA 10 comprising, in the signal reception path, two reception filters RXF1 and RXF2 connected to a low noise amplifier LNA and, in the transmission path, a transmission filter TXF. The receive and transmission paths are combined in two output/input ports, one port AP for connection with the Tx/Rx antenna arrangement ANT, and the other port BP for connection with the mobile base station.

The TMA filter 1, according to the invention, implements the three TMA 10 filter functions, two reception path filters RXF1, RXF2 and one transmission path filter TXF. The TMA filter 1 of FIG. 1A is a triplexer filter, the filters being of the band pass type.

FIG. 1B shows a typical dual duplex arrangement of a TMA 10. It is a paired configuration in which the functions are doubled. The TMA filter 1 comprises in this case a doubled triplexer filter functionality. Triple arrangements or any other multiple of the basic arrangement shown in FIG. 1A are also possible.

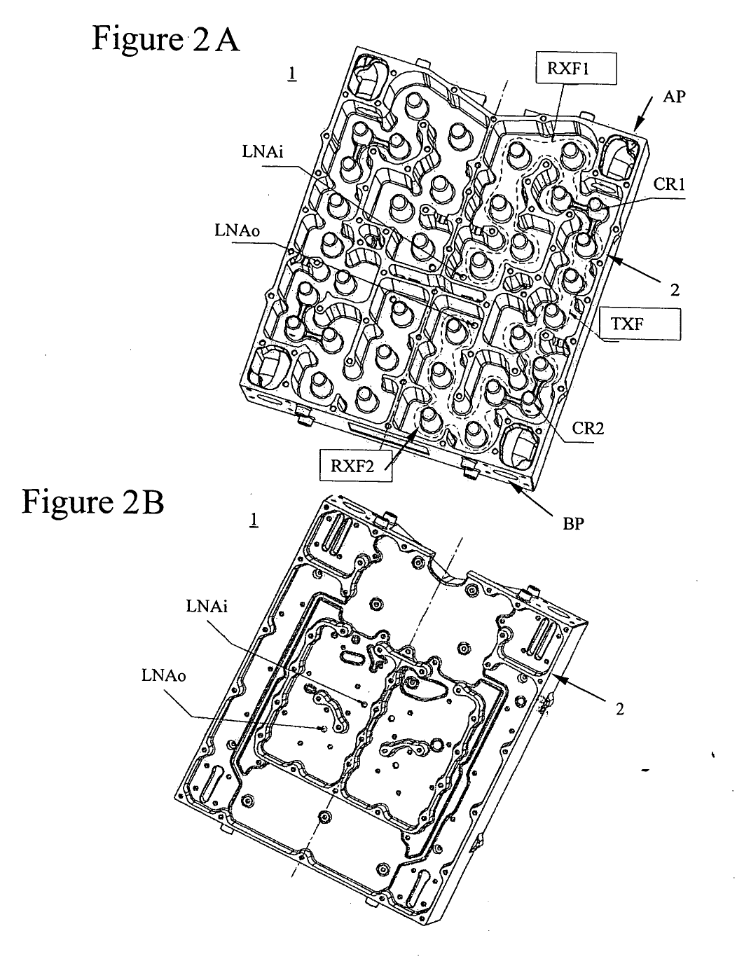

FIG. 2A shows a perspective sectional front view of the preferred embodiment of the TMA filter 1 implementation according to the present invention. The TMA filter 1 is a coaxial cavity filter which implements the double triplexer filter functionality shown in FIG. 1B. For the sake of simplification we will explain here only one of the triplexer functionality, that is, the implementation of the signal reception path filters RXF1 and RXF2 and transmission path filter TXF.

The cavities are manufactured by moulding a filter body housing 2 in thermoplastic material with high content of glass- and mineral-fillers for low coefficient of expansion. The polymer filter is then coated with an electrical conductive material, such as for example copper or silver-plating. The plating process is usually made by electro-deposited silver on top of a thin layer of chemical copper and electrolytic copper.

In FIG. 2A are also shown the common resonators CR1 and CR2 for the reception and transmission signal filter paths, the low noise amplifier input LNAi and output LNAo openings, and the filter connector ports AP, BP for connection with external devices.

FIG. 2B shows a perspective sectional back view of the preferred embodiment of the TMA filter 1 implementation according to the present invention. The back side of the filter body housing 2 is designed so that it provides cavities to mount the low noise amplifiers LNA and their corresponding input LNAi and output LNAo openings.

The trimming plate or cover of the body housing 2 can be either manufactured in coated/plated aluminum or moulded in the same thermoplastic material as the filter body 2 and then coated. The conventional aluminum trimming plate is normally secured to the filter body by mounting self tapping or self cutting screws into the filter body. If the trimming plate is made in thermoplastic, the mounting to the filter body 2 can be performed by several new methods as e.g. reflow soldered, glued with conductive glue or laser welded to the filter.

Over each of the cavity resonators there is a thread in which a tuning screw is mounted. By adjusting the screws towards the top of the resonators, the filter is tuned to its frequency, attenuation specs, return loss and insertion loss. When the position of the screw is correct, it is secured by means of a counter nut.

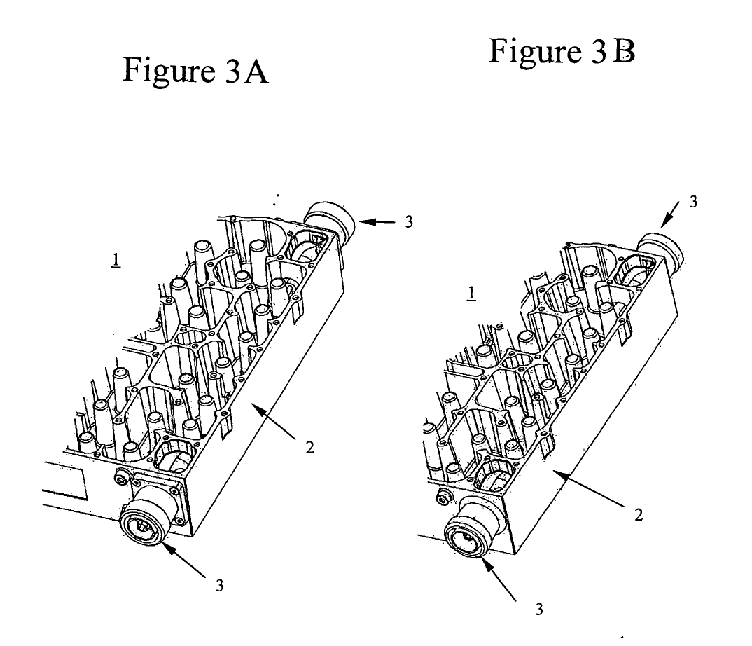

FIG. 3A shows a perspective partial view of a TMA filter 1 according to the invention with connectors 3 mounted onto the housing 2.

In a typical arrangement of a mobile network base station, the inner filter cavity resonators are coupled to external devices, for example an antenna, by means of a coaxial connector 3 mounted onto the housing 2 of the TMA filter 1.

In FIG. 3A, the coaxial connectors 3 are mounted on the TMA filter 1 housing 2 by means of screws or by press-fit.

Alternatively, also according to the invention, the TMA filter 1 housing 2 can be moulded together with the connectors 3, as shown in FIG. 3B, so that the connectors 3 constitute an integrated part of the housing 2.

To mould the filter together with the connectors reduces overall equipment weight, cost, assembly time and optimizes passive intermodulation performance. For example, the weight of the final TMA filter product can be 40% lighter compared to conventional aluminum TMA filters.

1. A tower mounted amplifier filter for use in mobile base station antenna masts comprising three TMA filter functions, two reception path filters separated by a low noise amplifier and one transmission path filter, implemented by means of coaxial resonator cavities, two of them being common resonators where the receive and transmission paths are combined in two output/input ports for connection with external devices, the body housing of the filter being made of thermoplastic material with high content of glass- and mineral-fillers, and coated with an electrical conductive material.

2. The tower mounted amplifier filter of claim 1 comprising a double, triple or any multiple of the basic triplexer filter functionality.

3. The tower mounted amplifier filter of claim 1 characterized in that it is designed to have a cavity for mounting the low noise amplifier at the back side of the filter housing and the corresponding openings.

4. The tower mounted amplifier filter of claim 1 further comprising the connectors as an integral part of the body housing.

5. A method for manufacturing a tower mounted amplifier filter for use in mobile base station antenna masts comprising three TMA filter functions, two reception path filters separated by a low noise amplifier and one transmission path filter, implemented by means of coaxial resonator cavities, two of them being common resonators where the receive and transmission paths are combined in two output/input ports for connection with external devices, the body housing of the filter being made of thermoplastic material with high content of glass- and mineral-fillers, and coated with an electrical conductive material, comprising the following steps:
moulding the filter body housing in thermoplastic,
coating said housing with an electrical conductive material, and
fitting a trimming plate to cover the body housing.

6. The method of claim 5 characterized in that the filter body housing is moulded together with the filter connectors to form an integrated product.

7. The method of claim 5 characterized in that the trimming plate is moulded in the same thermoplastic material as the filter body and mounted on it by reflow soldering, gluing with conductive glue or laser welding.

8. The method of claim 5 characterized in that the thermoplastic material has high content of glass- and mineral-fillers.
